(19) United States
(12) Patent Application Publication
(10) Pub. No.: US 2009/0263665 A1
(43) Pub. Date: Oct. 22, 2009

(54) LUMINESCENT PRODUCT AND PROCESS FOR PRODUCING THE SAME

(76) Inventors: Takashi Kamiike, Ibaraki (JP); Takashi Yokoyama, Ibaraki (JP)

Correspondence Address: HARNESS, DICKEY & PIERCE, P.L.C., P.O. BOX 828, BLOOMFIELD HILLS, MI, 48303, US

(21) Appl. No.: 12/375,619

(22) PCT Filed: Apr. 6, 2007
(86) PCT No.: PCT/JP2007/058123

§ 371 Date: Jan. 29, 2009

(30) Foreign Application Priority Data
Aug. 11, 2006 (JP) 2006-219216

(51) Int. Cl. B32B 27/40; B28B 1/20

(52) U.S. Cl. 428/423.1; 264/311

(57) ABSTRACT

A luminescent product molded by centrifugal molding which is inhibited from curling and has a white layer for improving phosphorescent performance. The product comprises: a hiding layer formed from a first mixture which is a mixture of a first thermosetting resin and a pigment by subjecting the mixture to centrifugal molding with heating; a phosphorescent layer obtained from a second mixture which is a mixture of a second thermosetting resin and a phosphorescent pigment having a higher specific gravity than the second thermosetting resin by pouring the second mixture on the hiding layer and subjecting it to centrifugal molding with heating; and a transparent layer. The phosphorescent layer is located nearly at the center of the product thickness. Thus, the product can be effectively inhibited from curling.

### CROSS-REFERENCE TO RELATED APPLICATIONS

This is a national stage of the International Application No. PCT/JP2007/058123 filed on Apr. 6, 2007 and published in Japanese language.

### BACKGROUND OF THE INVENTION

1. Field of the Invention

The present invention relates to a luminescent product such as a guide signboard, a safety signboard, a safety guidance indicating board, or the like, and a process for producing the product.

2. Description of the Conventional Art

It is conventionally known that, when resin and rubber products containing a phosphorescent pigment are molded, the most efficient process for increasing a phosphorescent pigment concentration on one side surface (a luminescent surface) for improving a function of the phosphorescent pigment is a process that a phosphorescent pigment is mixed with a thermosetting resin and molding is carried out by a centrifugal method (Japanese Patent No. 3295229).

However, curling occurs in every phosphorescent material-containing product molded by this process.

Although a layer much containing an inorganic phosphorescent material shrinks a little after molding, a layer less containing a phosphorescent material shrinks greatly. As a result, curling occurs in the direction of the layer less containing a phosphorescent material due to the difference of shrinkage.

That is, as illustrated in FIG. 3, in a product produced by successively laminating a phosphorescent layer 200 and a transparent layer 300 on a hiding layer 100, curling occurs at the hiding layer 100 side.

Therefore, a product molded by the above-described centrifugal molding can not be in a flat board shape, and thus the product is restricted in an application for use (cannot be used for a guide board, a guide sign, a road sign, and the like which are used in a board shape).

### SUMMARY OF THE INVENTION

### Problem to be Solved by the Invention

The present invention is to solve the above-described problem, and an object of the present invention is to provide a luminescent product molded by centrifugal molding method, which is inhibited from curling and has a white layer for improving phosphorescent performance.

### Means for Solving the Problem

In order to attain the above-described object, a luminescent product according to the present invention includes a hiding layer formed from a first mixture which is a mixture of a first thermosetting resin and a pigment by subjecting the mixture to centrifugal molding with heating, and a phosphorescent layer and a transparent layer which are obtained from a second mixture which is a mixture of a second thermosetting resin and a phosphorescent pigment having a higher specific gravity than the second thermosetting resin by pouring the second mixture on the hiding layer and subjecting it to centrifugal molding with heating. The phosphorescent layer is located nearly at a center of a product thickness.

Further a process for producing a luminescent product according to the present invention includes a first step for forming a hiding layer from a first mixture which is a mixture of a first thermosetting resin and a pigment by subjecting the mixture to centrifugal molding with heating, and a second step for forming a phosphorescent layer and a transparent layer from a second mixture which is a mixture of a second thermosetting resin and a phosphorescent pigment having a higher specific gravity than the second thermosetting resin by pouring the second mixture on the hiding layer and subjecting it to centrifugal molding with heating. The phosphorescent layer is molded so as to be located nearly at a center of a product thickness.

### EFFECTS OF THE INVENTION

The present invention has the following effects.

According to a luminescent product of a first aspect of the present invention, since the phosphorescent layer having different heat shrinkage from that of the hiding layer and the transparent layer is located at a center in the thickness direction of the product, the product molded by centrifugal molding method can be effectively inhibited from curling.

According to the luminescent product of a second aspect of the present invention, the luminescent product can have a white layer for improving phosphorescent performance.

According to the luminescent product of a third aspect of the present invention, heat shrinkage of the hiding layer and heat shrinkage of the transparent layer can be made approximately equal.

According to the luminescent product of a fourth aspect of the present invention, the product can be easily molded and proper product performance can be obtained.

According to the luminescent product of a fifth aspect of the present invention, the phosphorescent layer and the transparent layer can be formed as one layer.

According to a process for producing a luminescent product of a sixth aspect of the present invention, a luminescent product which is effectively inhibited from curling can be easily molded by centrifugal molding method.

According to the process for producing a luminescent product of a seventh aspect of the present invention, the hiding layer and the phosphorescent layer can be strongly integrated without using an adhesive.

According to the process for producing a luminescent product of an eighth aspect of the present invention, the luminescent product can have a white layer for improving phosphorescent performance.

According to the process for producing a luminescent product of a ninth aspect of the present invention, the product can be easily molded and proper product performance can be obtained.

According to the process for producing a luminescent product of a tenth aspect of the present invention, the hiding layer and the phosphorescent layer are well compatible.

According to the process for producing a luminescent product of an eleventh aspect of the present invention, the hiding layer having a uniformly dispersed white pigment can be molded easily.

According to the process for producing a luminescent product of a twelfth aspect of the present invention, the phosphorescent layer and the transparent layer can be separated clearly.

### BRIEF EXPLANATION OF DRAWINGS

FIG. 1 is a schematic sectional view to illustrate a luminescent product according to an example of the present invention,

FIG. 2 is a schematic sectional view to illustrate a luminescent product according to another example of the present invention, and

FIG. 3 is a schematic sectional view to illustrate a luminescent product according to a conventional art.

### DETAILED DESCRIPTION OF PREFERRED EMBODIMENT

Preferred embodiments for carrying out of the present invention will be described below.

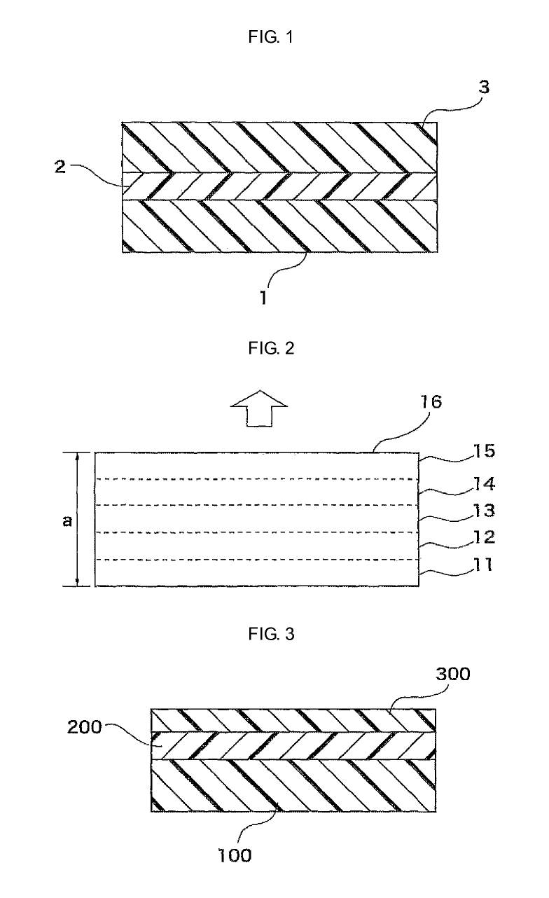

A preferred embodiment for carrying out of the present invention will be described with reference to FIG. 1.

FIG. 1 is a schematic sectional view to illustrate a luminescent product according to an example of the present invention.

A hiding layer 1 is formed from a first mixture which is a mixture of a first thermosetting resin made of a urethane material and a white pigment by subjecting the mixture to centrifugal molding with heating. A phosphorescent layer 2 and a transparent layer 3 are formed from a second mixture which is a mixture of a second thermosetting resin made of a urethane material and a phosphorescent pigment having a higher specific gravity than the second thermosetting resin by pouring the second mixture on the hiding layer and subjecting it to centrifugal molding with heating.

The phosphorescent layer 2 is formed so as to be located nearly at a center of the luminescent product thickness, and the hiding layer 1 and the transparent layer 3 have an approximately equal thickness.

Further, the thickness of a whole product is approximately 1 to 10 mm.

Then, a process for producing a luminescent product according to this example will be described.

In a process for producing a luminescent product according to this example, a centrifugal molding method by heating and rotating is used, and a urethane material is used as a thermosetting resin. A phosphorescent layer containing a phosphorescent pigment and a transparent layer containing almost no phosphorescent pigment are molded from a mixture of a phosphorescent pigment having a higher gravity than the urethane material with polyurethane by utilizing a gravity difference of these materials through centrifugal molding method.

In addition, the phosphorescent layer and the transparent layer are formed by pouring the mixture after a time when the hiding layer begins to harden and before a time when the hiding layer completely hardens, and subjecting it to centrifugal molding, where the hiding layer is the mixture including the urethane material containing the white pigment.

In this case, the words of before the time when the hiding layer completely hardens means before a time when an unreacted reaction group dose not remain anymore in the hiding layer. The urethane material in this example is a pouring type urethane material, and becomes polyurethane by reacting of a main material having a reaction group called as prepolymer (—NCO) and a hardening agent (amine based).

In the urethane material constituting the first mixture, the main material and the hardening agent are mixed, poured, and thereafter hardened. However, the second mixture is poured thereon when an unreacted reaction group still remains whereby the unreacted reaction group in the first mixture (a molded material) is reacted with the second mixture.

Thereby, a molded material, in which a molded material from the fist mixture and the second mixture are integrated, can be made.

A process for producing a luminescent product will be described in detail below.

### (Step 1)

The first mixture is obtained by mixing 30 parts by weight (hereinafter simply called as parts) of a non-yellowing polyurethane prepolymer as a first thermosetting resin, 3 parts of an amine based hardening agent, and 2 parts of an inorganic white pigment (titanium white, an average particle diameter of 20 μm) as a pigment, and stirring those. Then, the hiding layer 1 is formed by pouring the first mixture into a centrifugal molding machine, and subjecting it to centrifugal molding under the conditions of a temperature of 110° C. and a rotation rate of 150 rpm.

The rotation rate of the centrifugal molding machine is 50 to 500 rpm, and preferably 100 to 200 rpm.

By such the low rate centrifugal molding, the white pigment is uniformly dispersed in the first mixture.

A particle diameter of the white pigment (titanium white) to be used is preferably 30μ or less for uniformly dispersing.

### (Step 2)

A second mixture is obtained by mixing 100 parts of a non-yellowing polyurethane prepolymer as a second thermosetting resin, 10 parts of an amine based hardening agent, and 20 parts of a phosphorescent pigment (having an average particle diameter of 150 μm), and stirring those. After carrying out the centrifugal molding for 10 minutes under the conditions shown in step 1, the second mixture is poured into the centrifugal molding machine, and subjected to centrifugal molding for 20 minutes under the conditions of a temperature of 110° C. and a rotation rate of 1000 rpm, and thus molded product is taken out from the centrifugal molding machine.

In this case, as for the phosphorescent pigment, for example, strontium oxide, aluminum oxide, rare earth oxides, or the like having an average particle diameter of 30 to 300 μm, preferably 100 to 250 μm, can be properly applied.

The rotation rate of the centrifugal molding machine is 600 to 1500 rpm, and preferably 800 to 1200 rpm.

Further, a molding temperature is preferably within a range of 60 to 150° C.

### (Step 3)

After the molded product is taken out from the centrifugal molding machine in step 2, a sheet-shaped luminescent product is obtained by subjecting it to heat treatment for 12 hours at a temperature of 100° C.

Accordingly, by carrying out centrifugal molding under the conditions described in step 1, the hiding layer 1 containing the white pigment is formed.

Further, by carrying out centrifugal molding under the conditions described in step 2, the phosphorescent layer 2 very much containing the phosphorescent pigment and the transparent layer 3 almost not containing the phosphorescent material are formed on the hiding layer 1 containing the white pigment.

Accordingly, by carrying out molding in step 2 at the higher rotation rate than the rotation rate in step 1, the transparent layer not containing the phosphorescent pigment can be formed.

Then, another embodiment of the present invention will be described with reference to FIG. 2.

As illustrated in FIG. 2, the luminescent product includes a white reflection layer (a functional layer) 11 very much containing a white pigment, a buffer layer 12 a little containing a white pigment, a phosphorescent material layer (a functional layer) 13 very much containing a phosphorescent pigment (hereinafter called as a phosphorescent material), a buffer layer 14 a little containing a phosphorescent material, and a surface layer (a functional layer) 15 not containing (almost not containing) a phosphorescent material, and these layers are laminated in order.

Further, in the luminescent product, a surface of the surface layer 15 is to be a luminescent face 16. That is, the luminescent product luminesces toward the arrow direction indicated in FIG. 2. Further, as illustrated in FIG. 2, in this example, the luminescent product including the white reflection layer 11, the buffer layer 12, the phosphorescent material layer 13, the buffer layer 14 and the surface layer 15, which are laminated, has thickness a of 1 to 10 mm.

A process for producing another example of the present invention will be described in detail below.

### (Step 1)

A first mixture is obtained by mixing 30 parts by weight (hereinafter simply called as parts) of a non-yellowing polyurethane prepolymer as an urethane material, 3 parts of an amine based hardening agent, and 3 parts of an inorganic white pigment (titanium white, an average particle diameter of 20 μm) as a first inorganic material, and stirring those. Then, the first mixture is poured into a centrifugal molding machine and subjected to centrifugal molding under the conditions of a temperature of 110° C. and a rotation rate of 1000 rpm.

### (Step 2)

A second mixture is obtained by mixing 100 parts of a non-yellowing polyurethane prepolymer, 10 parts of an amine based hardening agent, and 20 parts of a phosphorescent pigment (having an average particle diameter of 150 μm) as a second inorganic material, and stirring those. After carrying out centrifugal molding for 10 minutes under the conditions described in step 1, the second mixture is poured into the centrifugal molding machine, and subjected to centrifugal molding for 2 minutes under the conditions of a temperature of 110° C. and a rotation rate of 1500 rpm. Then, the mixture is further subjected to molding for 20 minutes after lowering the rotation rate to be 1000 rpm, and thus molded product is taken out from the centrifugal molding machine.

In this case, as for the phosphorescent pigment, for example, strontium oxide, aluminum oxide, rare earth oxides or the like can be properly applied.

### (Step 3)

After the molded product is taken out from the centrifugal molding machine in step 2, a sheet-shaped luminescent product is obtained by subjecting it to heat treatment for 12 hours at a temperature of 80° C.

Accordingly, by carrying out centrifugal molding under the conditions shown in step 1, a molded material having two layers of the white reflection layer 11 very much containing the white pigment and the buffer layer 12 a little containing the white pigment can be molded.

In this case, the centrifugal molding is carried out at the rotation rate of 1000 rpm in the condition of step 1. However, the rotation rate may be from 200 to 2000 rpm.

Further, by carrying out the centrifugal molding under the conditions in step 2, the phosphorescent material layer 13 very much containing the phosphorescent material, the buffer layer 14 a little containing the phosphorescent material, and the surface layer 15 not containing the phosphorescent material are formed, in addition to the white reflection layer 11 and the buffer layer 12. Accordingly, by carrying out molding in step 2 at the higher rotation rate than the rotation rate in step 1, the layer (the surface layer 15) not containing the phosphorescent material can be formed. In this case, the white reflection layer 11 and the buffer layer 12 constitute the hiding layer 1 according to the present invention, and the buffer layer 14 a little containing the phosphorescent material and the surface layer 15 not containing the phosphorescent material constitute the transparent layer 3 according to the present invention.

In this connection, in step 2, the molding may be carried out for 1 to 3 minutes at the rotation rate increased by 20 to 50 percents from the rotation rate in step 1 (at the rotation rate of 220 to 3000 rpm), and further carried out for 10 to 30 minutes at the original rotation rate (at the rotation number of 200 to 2000 rpm) after returning the rate thereto, and then thus molded product is taken out from centrifugal molding machine.

In this case, when a layer much containing a phosphorescent pigment and a layer less containing a phosphorescent pigment are formed by centrifugal molding, heat shrinkage is different between the layer much containing the phosphorescent pigment and the layer less containing the phosphorescent pigment.

Strontium oxide, aluminum oxide, rare earth oxides or the like, which is used as the phosphorescent pigment, hardly shrinks at a heat treatment temperature of approximately 100° C. Therefore, the phosphorescent layer much containing such the phosphorescent pigment hardly shrinks. On the other hand, the transparent layer 3 almost not containing the phosphorescent pigment shrinks.

Similarly, the hiding layer 1 a little containing the white pigment shrinks like the transparent layer 3. However, since the phosphorescent layer 2 is located nearly at the center of the product thickness, the whole product is not curled.

Thus, the hiding layer 1 and the transparent layer 3 have an approximately equal thickness. However, when the hiding layer 1 contains a white pigment of 1% or less, the thickness of the hiding layer may be slightly thickened in comparison with the thickness of the transparent layer 3.

1.-12. (canceled)

13. A luminescent product comprising:
a hiding layer formed from a first mixture being a mixture of a first thermosetting resin and a pigment by subjecting the mixture to centrifugal molding with heating; and
a phosphorescent layer and a transparent layer which are obtained from a second mixture being a mixture of a second thermosetting resin and a phosphorescent pigment having a higher specific gravity than the second thermosetting resin by pouring the second mixture on the hiding layer and subjecting it to centrifugal molding with heating, wherein the phosphorescent layer is located nearly at a center of a product thickness.

14. The luminescent product as claimed in claim 13, wherein the pigment mixed with the first thermosetting resin is a white pigment.

15 The luminescent product as claimed in claim 13, wherein the second thermosetting resin is transparent polyurethane.

16. The luminescent product as claimed in claim 14, wherein the second thermosetting resin is transparent polyurethane.

17. A process for producing a luminescent product, the process comprising:
a first step for forming a hiding layer from a first mixture being a mixture of a first thermosetting resin and a pigment by subjecting the mixture to centrifugal molding with heating; and
a second step for forming a phosphorescent layer and a transparent layer from a second mixture being a mixture of a second thermosetting resin and a phosphorescent pigment having a higher specific gravity than the second thermosetting resin by pouring the second mixture on the hiding layer and subjecting it to centrifugal molding with heating,
wherein the phosphorescent layer is located nearly at a center of a product thickness.

18. The process for producing a luminescent product as claimed in claim 17, wherein the second step start when the hiding layer formed in the first step does not yet harden and an un-reacted functional group still remains in the hiding layer.
